(19) United States
(12) Patent Application Publication
(10) Pub. No.: US 2015/0247486 A1
(43) Pub. Date: Sep. 3, 2015

(54) WIND TURBINE

(71) Applicant: Wepfer Technics AG, Andelfingen (CH)

(72) Inventor: Hans Wepfer, Berg-Daegerlen (CH)

(73) Assignee: Wepfer Technics AG, Andelfingen (CH)

(21) Appl. No.: 14/426,904

(22) PCT Filed: Sep. 10, 2013
(86) PCT No.: PCT/CH2013/000161

§ 371 Date: Mar. 9, 2015

(30) Foreign Application Priority Data
Sep. 10, 2012 (CH) 1647/12

(51) Int. Cl. F03D 1/02; F03D 11/04; F03D 7/02

(52) U.S. Cl. CPC F03D 1/02; F03D 7/0204; F03D 7/0224; F03D 7/0268; F03D 11/04

(57) ABSTRACT

The present invention relates to a wind turbine installation comprising at least two wind turbines (7, 7′) on a turbine carrier (5). Which, by means of tower supports (4, 4′), is mounted on a rotating pedestal (2) so as to be rotatable in relation to a tower console (1).

### TECHNICAL FIELD

The present invention relates to a wind turbine installation as claimed in claim 1.

### PRIOR ART

Wind turbines have already been known for a long time as power generators. Powerful wind turbines follow one simple rule, that is to design the hub height and rotor circle to be as large as possible. Visibility, noise and shadow coverage are enormous. This fact means that wind turbines are always erected further away from civilian areas, whether on-or offshore. The very long access routes resulting therefrom, including service and maintenance costs, are anything but resource- and cost-effective.

It is an object of the invention to design a wind turbine installation such that it can be built close to civilian areas and thus saves on resources and costs. This is achieved by a flat, rotor-circle-reduced and modular construction.

### SUMMARY OF THE INVENTION

One aspect of the present invention relates to a wind turbine installation comprising a turbine carrier on tower supports. At least two wind turbines are provided on the turbine carrier. The wind turbines are mounted rotatably by means of a rotating pedestal on a tower console.

In one particular embodiment, the wind turbine installation is designed such that the turbine carrier can rotate about the vertical axis via the rotating pedestal.

In one particular embodiment, the turbine carrier is designed such that it can control a rotation about the vertical axis for yaw adjustment in relation to the wind direction. This embodiment furthermore preferably has a wind sensor for detecting the wind direction and a position motor for rotating the turbine carrier via the rotating pedestal.

In one particular embodiment, the turbine carrier with the turbine is designed such that it can be lowered by means of a drive. In this embodiment, the tower supports are designed in an articulated manner and as a parallelogram.

In one particular embodiment, a pitch axis of the turbine is designed to be adjustable by means of a length adjuster via the tower support.

In one particular embodiment of the present invention, turbine carrier, tower supports and turbines are designed to be modular according to the modular principle.

In one particular embodiment, the tower supports are arranged in the interspace of the rotor circles of the wind turbines.

In one particular embodiment, the wind turbine installation is designed in such a way that the wind force itself undertakes the yaw adjustment via a point of rotation. In a further, particular embodiment, the wind turbine installation has three offset turbines, namely a left turbine, a right turbine and a central turbine. The central turbine is arranged at the point of rotation and is the foremost turbine. The left and the right turbines flank the central turbine and are offset rearwardly in the wind direction.

In one particular embodiment, the wind turbine installation is designed such that it can be used on- and offshore via the tower console.

In one particular embodiment, the wind turbine installation is designed such that it can be used on a ship via the tower console. A further aspect of the present invention relates to the use of a wind turbine installation as described above on a ship.

### BRIEF DESCRIPTION OF THE DRAWINGS

Further advantageous embodiments and combinations of features of the invention will become apparent from the detailed description given below and from all the patent claims.

In the drawings used to illustrate the exemplary embodiment:

FIG. 1 shows a wind turbine installation according to the invention with one possible arrangement of two wind turbines in front view.

FIG. 2 shows a wind turbine installation according to the invention in side view.

FIG. 3 shows a wind turbine installation according to the invention in side view with a lowering mechanism.

FIG. 4 shows a wind turbine installation according to the invention with one possible arrangement of seven wind turbines in front view.

FIG. 5 shows a wind turbine installation according to the invention in plan view.

In principle, identical parts are provided with identical reference signs in the figures.

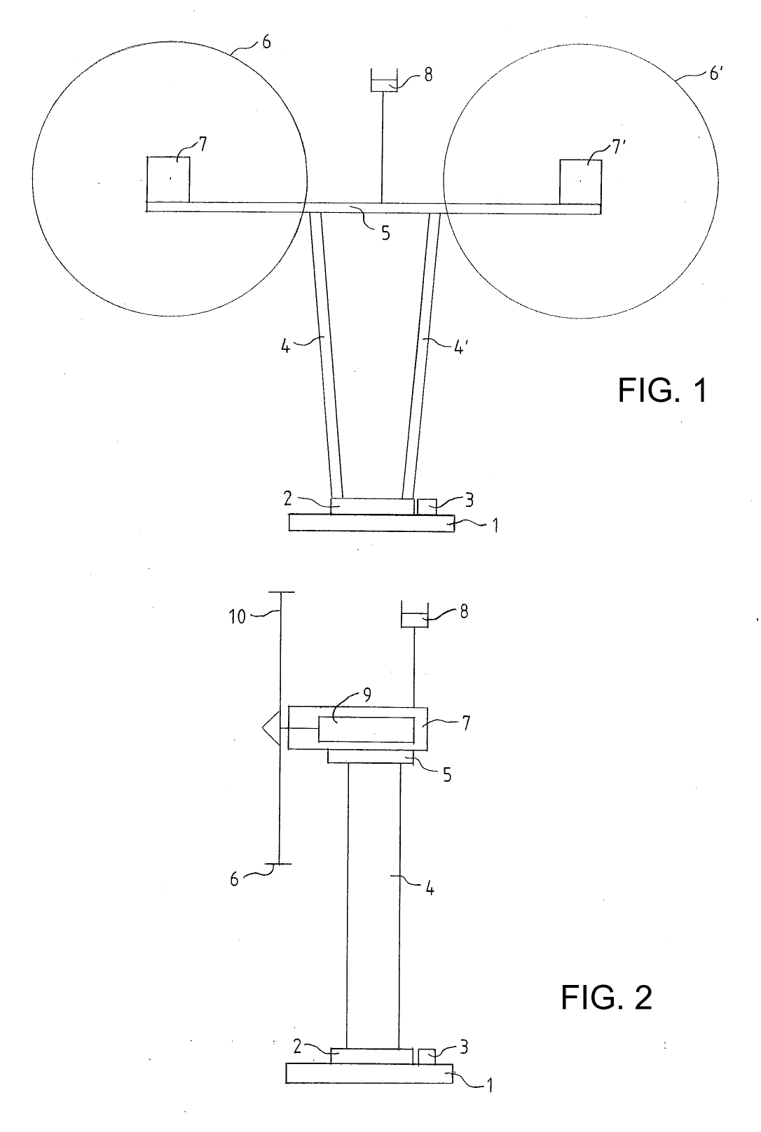

FIG. 1 shows a turbine installation, where, according to one embodiment, two wind turbines 7, 7′ are mounted on a horizontal turbine carrier 5. A tower support 4, 4′ is used to connect a turbine carrier 5 to a rotating pedestal 2. The rotating pedestal 2 rotates on a stable tower console 1 and is wind-direction-controlled (yaw) via a wind sensor 8 and by means of a position motor 3. Therefore, a rotor circle 6, 6′ is always placed optimally in relation to the wind direction.

FIG. 2 shows the wind turbine 7 with a generator 9, a rotor blade 10 with a rotor circle 6, mounted on the horizontal turbine carrier 5. The horizontal tower carrier 5 is connected via a tower support 4 to a rotating pedestal 2 which is mounted on a stable tower console 1.

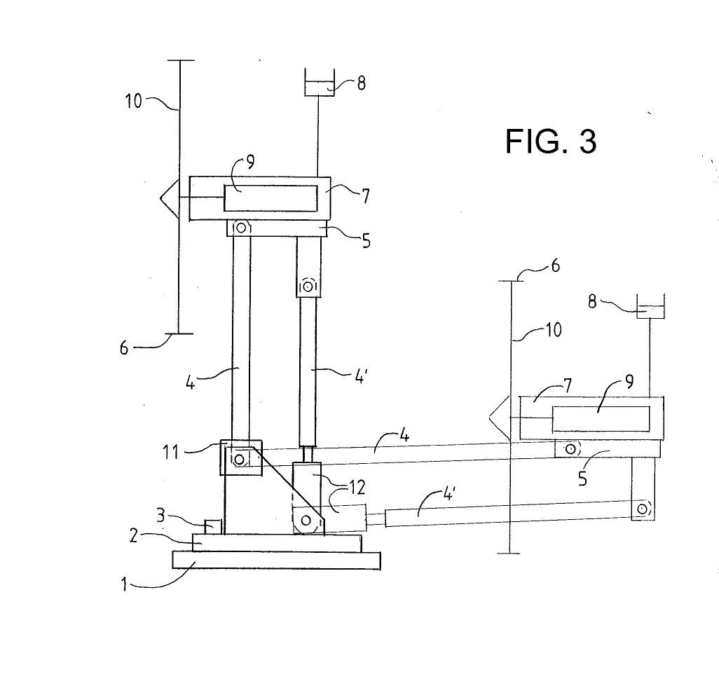

FIG. 3 shows a lowerable wind turbine 7 which is advantageous in very severe weather conditions or for servicing. The lowering operation takes places in parallel with the tower supports 4, 4′ by means of a drive 11. The position of the wind turbine 7 can be varied by a length adjuster 12.

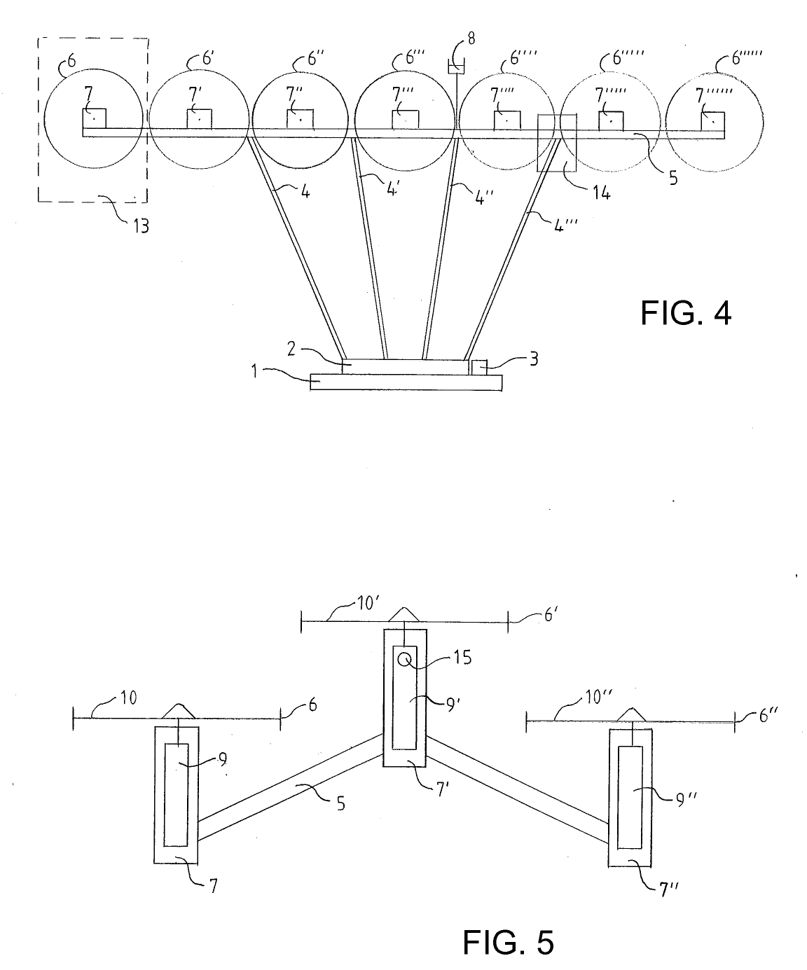

FIG. 4 shows a turbine installation, where, according to one embodiment, seven wind turbines 7, 7′, 7″, 7″′, 7″″, 7″″′, 7″″″ are mounted on a horizontal turbine carrier 5. This can advantageously be achieved with a modular construction according to the modular principle 13.

FIG. 5 shows a turbine installation, where, according to one embodiment, three wind turbines 7, 7′, 7″ are mounted on a horizontal turbine carrier 5. A left wind turbine 7 and a right wind turbine 7″ are offset rearwardly in the wind direction with respect to a central wind turbine (7′). A point of rotation 15 in the central wind turbine 7′ contributes to the fact that this turbine installation can be positioned in relation to the wind direction automatically and only with wind force.

1. A wind turbine installation comprising a turbine carrier on tower supports, wherein at least two turbines are provided on the turbine carrier and are arranged rotatably by means of a rotating pedestal on a tower console.

2. The wind turbine installation as claimed in claim 1, wherein the turbine carrier can rotate about the vertical axis via the rotating pedestal.

3. The wind turbine installation as claimed in claim 1, wherein the turbine carrier can be positioned rotatably about the vertical axis for yaw adjustment by means of a wind sensor via a rotating pedestal with a position motor in relation to the wind direction in such a way that the turbines always have a rotor axis which extends perpendicular to the wind direction.

4. The wind turbine installation as claimed in claim 1, wherein the turbine carrier with the turbines is designed to be lowerable by means of a drive via tower supports designed in an articulated manner as a parallelogram.

5. The wind turbine installation as claimed in claim 4, wherein a pitch axis of the turbines is designed to be adjustable by means of a length adjuster via the tower support.

6. The wind turbine installation as claimed in claim 1, wherein turbine carrier, tower supports and turbines are designed to be modular according to the modular principle.

7. The wind turbine installation as claimed in claim 1, wherein the tower supports are arranged in an interspace between the rotor circles of the turbines.

8. The wind turbine installation as claimed in claim 1, wherein the wind power turbine is designed in such a way that the wind force itself undertakes the yaw adjustment, in particular via a point of rotation in a central turbine.

9. The wind turbine installation as claimed in claim 1, wherein the wind turbine installation can be used on-and offshore via the tower console.

10. The wind turbine installation as claimed in claim 1, wherein the wind turbine installation can be used on a ship via the tower console.

11. A wind turbine installation comprising a turbine carrier on tower supports, whereby at least two turbines are provided on the turbine carrier and are mounted such that a rotating pedestal rotates on a stable tower console.
